(19) United States
(12) Patent Application Publication
(10) Pub. No.: US 2015/0316966 A1
(43) Pub. Date: Nov. 5, 2015

(54) ELECTRONIC DEVICE WITH IMPROVED HEAT DISSIPATION

(71) Applicant: Taiwan Green Point Enterprises Co., Ltd., Taichung City (TW)

(72) Inventors: Yung-Chih CHEN, Taichung City (TW); Jun-Wei SU, Taichung City (TW); Chien-Hsiang HSIEH, Taichung City (TW); Jung-Chi LIU, Taichung City (TW); Yu-Lin HSIEH, Taichung City (TW)

(73) Assignee: TAIWAN GREEN POINT ENTERPRISES CO., LTD., Taichung City (TW)

(21) Appl. No.: 14/698,457

(22) Filed: Apr. 28, 2015

(30) Foreign Application Priority Data
May 1, 2014 (TW) 103115703
May 29, 2014 (TW) 103118790

(51) Int. Cl. G06F 1/20; G06F 1/16

(52) U.S. Cl. CPC G06F 1/20; G06F 1/1658

(57) ABSTRACT

An electronic device may include: a circuit board having a board surface; a heat-generating source including a first electronic component mounted on the board surface of the circuit board; and a heat dissipating panel stacked over the circuit board, having a panel surface, and formed with a first recess that is indented inwardly from the panel surface and that is defined by a first recess-defining wall. The first electronic component protrudes from the board surface into the first recess to contact the first recess-defining wall.

### CROSS-REFERENCE TO RELATED APPLICATION

This application claims priority of Taiwanese Patent Application No. 103115703, filed on May 1, 2014, and further claims priority of Taiwanese Patent Application No. 103118790, filed on May 29, 2014.

### FIELD

Embodiments of the invention generally relate to an electronic device, more particularly to an electronic device including a heat dissipating panel.

### BACKGROUND

FIG. 1 illustrates an electronic device that includes a housing 12, a display panel 121 mounted to an open end of the housing 12, a circuit board 122 mounted in the housing 12, a heat dissipating panel 129 mounted in the housing 12, an EMI-shielding metal sheet 123 sandwiched between the circuit board 122 and the heat dissipating panel 129 for preventing electromagnetic interference (EMI), a battery 125 mounted to the display panel 121, a heat pipe 128 connected to the heat dissipating panel 129, and a plurality of electronic components 127 mounted on and electrically connected to the circuit board 122 and extending through the EMI-shielding metal sheet 123 toward the heat dissipating panel 129.

The electronic components 127 are in different sizes and shapes and have different heights relative to amounting surface of the circuit board 122. As such, only one of the electronic components 127 which has the largest height can reach the heat dissipating panel 129 to contact the latter, and there remains a relatively large air space among the electronic components 127. The heat generated from the electronic components 127 which do not contact the heat dissipating panel 129 can only be dissipated through the air space among the electronic components 127, which is relatively inefficient.

Hence, there is still a need for further improving heat dissipation of the electronic components of the aforesaid electronic device.

### SUMMARY

In certain embodiments of the disclosure, an electronic device may be provided. Such an electronic device may include: a circuit board having a board surface; a heat-generating source including a first electronic component mounted on the board surface of the circuit board; and a heat dissipating panel stacked over the circuit board, having a panel surface, and formed with a first recess that is indented inwardly from the panel surface and that is defined by a first recess-defining wall. The first electronic component protrudes from the board surface into the first recess to contact the first recess-defining wall.

In certain embodiments of the disclosure, an electronic device may include: a housing; a circuit board having a board surface; a heat-generating source comprising a first electronic component mounted on the board surface of the circuit board, where the first electronic component has a free end that is distal from the board surface; and a heat dissipating panel stacked over the circuit board, having a panel surface, and formed with a first recess that is indented inwardly from the panel surface and defined by a first recess-defining wall. The first recess-defining wall has an open end and a blind end that is opposite to the open end and that is distal from the panel surface. The free end of The first electronic component contacts the blind end of the first recess-defining wall. The heat dissipating panel contacts the housing.

### BRIEF DESCRIPTION OF THE DRAWINGS

Other features and advantages of the disclosure will become apparent in the following detailed description of the exemplary embodiments with reference to the accompanying drawings, of which:

FIG. 1 is an exploded perspective view of an electronic device;

FIG. 2 is an exploded perspective view of an electronic device of certain embodiments according to the disclosure;

FIG. 3 is a sectional view of the electronic device of FIG. 2;

FIG. 4 is an exploded perspective view of an electronic device of certain embodiments according to the disclosure;

FIG. 5 is a sectional view of the electronic device of FIG. 4;

FIG. 6 is a thermal image to illustrate thermal imaging data of a surface of an electronic device of FIG. 2; and

FIG. 7 is a thermal image to illustrate thermal imaging data of a surface of an electronic device of FIG. 1.

### DETAILED DESCRIPTION

It may be noted that like elements are denoted by the same reference numerals throughout the disclosure.

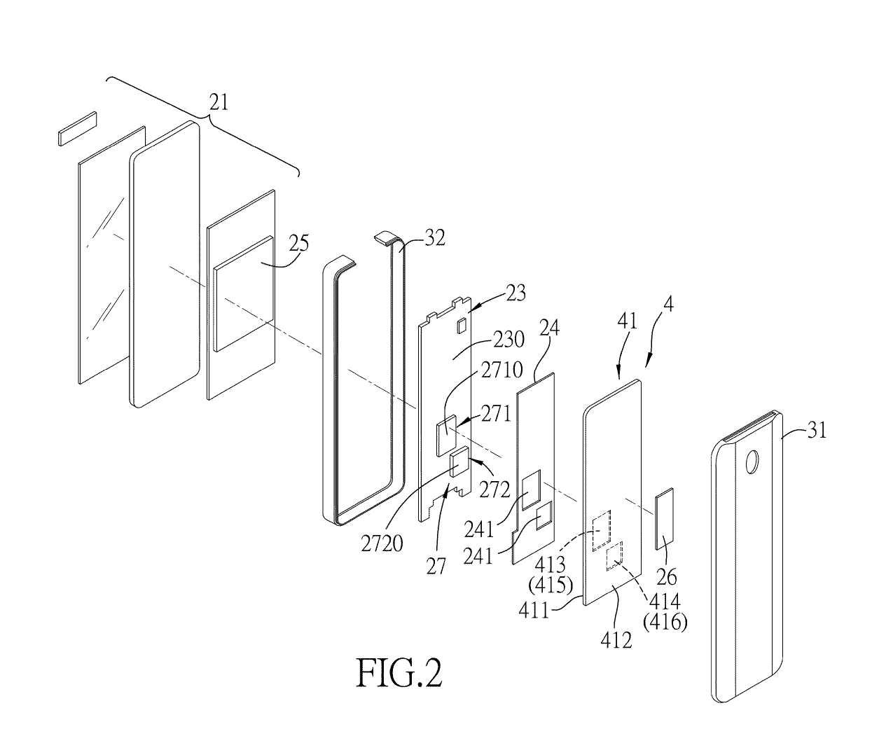

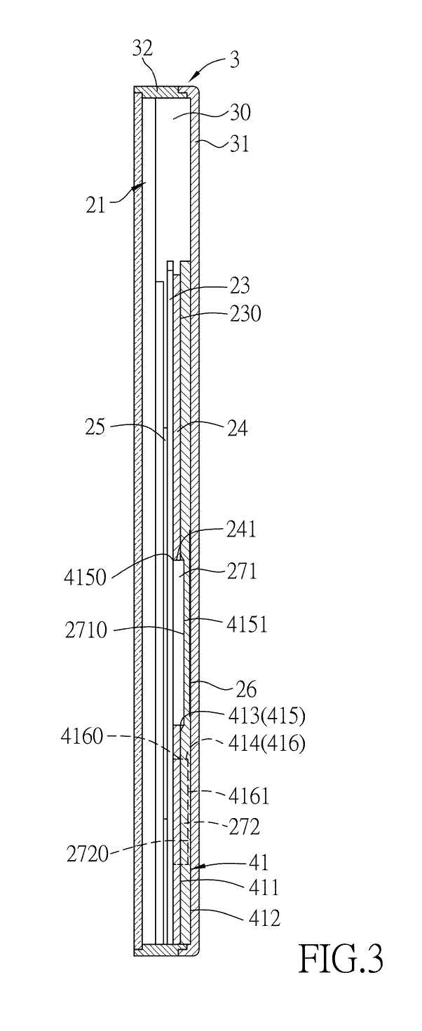

FIGS. 2 and 3 illustrate certain embodiments of an electronic device, such as a mobile phone, a notebook, and a tablet. Such an electronic device may include a housing 3, a circuit board 23, a EMI-shielding metal sheet 24, a heat-generating source 27, a heat dissipating unit 4, a display panel 21, a battery 25, and at least one insulator pad 26.

In certain embodiments, the housing 3 may include a back plate 31 and a frame part 32 that is detachably connected to the back plate 31 and that extends from a peripheral end of the back plate 31, so that the back plate 31 and the frame part 32 cooperatively define an accommodating space 30 therebetween.

In certain embodiments, the heat-generating source 27 includes first and second electronic components 271, 272 mounted on aboard surface 230 of the circuit board 23 and electrically connected to a circuit layer (not shown) of the circuit board 23. The first and second electronic components 271, 272 may be active or passive components, such as CPU chips, Memory chips, I/O chips, IC controller chips, etc.

In certain embodiments, the heat dissipating unit 4 includes a heat dissipating panel 41 that is stacked over the circuit board 23. The heat dissipating panel 41 has a planar front panel surface 411 and a planar rear panel surface 412, and is formed with first and second recesses 413, 414 that are indented inwardly from the front panel surface 411 and that are respectively defined by first and second recess-defining walls 415, 416. The first and second electronic components 271, 272 protrude from the board surface 230 into the first and second recesses 413, 414 to contact the first and second recess-defining walls 415, 416, respectively.

In certain embodiments, the rear panel surface 412 of the heat dissipating panel 41 may contact the back plate 31 for enhancing heat dissipation.

In certain embodiments, the EMI-shielding metal sheet 24 is formed with holes 241, and is sandwiched between the circuit board 23 and the heat dissipating panel 41 for preventing EMI. The first and second electronic components 271, 272 extend through the holes 241 in the EMI-shielding metal sheet 24. The EMI-shielding metal sheet 24 may contact the board surface 230 of the circuit board 23 and the front panel surface 411 of the heat dissipating panel 41.

In certain embodiments, the first electronic component 271 has a free end 2710 that is distal from the board surface 230. The first recess-defining wall 415 has an open end 4150 and a blind end 4151 that is opposite to the open end 4150 and that is distal from the panel surface 411. The free end 2710 of the first electronic component 271 contacts the blind end 4151 of the first recess-defining wall 415.

In certain embodiments, the second electronic component 272 has a free end 2720 that is distal from the board surface 230. The second recess-defining wall 416 has an open end 4160 and a blind end 4161 that is distal from the panel surface 411. The free end 2720 of the second electronic component 272 contacts the blind end 4161 of the second recess-defining wall 416.

In certain embodiments, the free ends 2710, 2720 of the first and second electronic components 271, 272 have different heights relative to the board surface 230, and the first and second recesses 413, 414 have different depths corresponding respectively to the heights of the free ends 2710, 2720 of the first and second electronic components 271, 272, so that the free ends 2710, 2720 of the first and second electronic components 271, 272 can contact the blind ends 4151, 4161 of the first and second recess-defining walls 415, 416, respectively, and so that a space between the first and second electronic components 271, 272 can be filled with the heat dissipating panel 41, which enhances dissipation of heat generated from the first and second electronic components 271, 272.

In certain embodiments, the first and second electronic components 271, 272 extend fittingly into the first and second recesses 413, 414.

In certain embodiments, the display panel 21 is mounted on an open end of the housing 3, and is surrounded by the frame part 32.

In certain embodiments, the EMI-shielding metal sheet 24 may be made from a stainless steel material, and the heat dissipating panel 41 is made from an alloy that has a melting point ranging from 80° C. to 120° C., so that the heat dissipating panel 41 may be easily shaped and machined, and welded to the EMI-shielding metal sheet 24.

In certain embodiments, the heat dissipating panel 41 is made from an alloy that comprises a primary alloy portion and a secondary alloy portion. The primary alloy portion may contain indium, gallium, and zinc. The secondary alloy portion may contain a metal selected from the group consisting of copper, cobalt, nickel, and chrome.

In certain embodiments, zinc may be present in the primary alloy portion in an amount of not greater than 10 parts by weight based on 100 parts by weight of the primary alloy portion, gallium is in an amount greater than indium in the primary alloy portion, and the secondary alloy portion is in an amount of less than 5 parts by weight based on 100 parts by weight of the primary alloy portion.

In certain embodiments, the primary alloy portion may further comprise a fourth metal (in addition to indium, gallium and zinc) that may be selected from the group consisting of silver, tin, and magnesium. The fourth metal may be in an amount less than 65 parts by weight based on 100 parts by weight of the primary alloy portion. In certain embodiments, the fourth metal may be tin.

In certain embodiments, the primary alloy portion contains 10 wt % indium, 20 wt % gallium, 5 wt % zinc and 60 wt % tin, and the secondary alloy portion contains 5 wt % copper. Such alloy has an average thermal conductivity ranging from 73.1 (W/mK) to 84.2 (W/mK), an average thermal diffusivity ranging from 3.3 (mm²/s) to 4.2 (mm²/s), and an average specific heat (MJ/m³K) ranging from 18.8 (MJ/m³K) to 23.6 (MJ/m³K), which are measured in accordance with a standard of ISO 220072/Hot Disk Method.

In certain embodiments, the insulator pad 26 is sandwiched between the back plate 31 and the heat dissipating panel 41 for isolating an antenna (not shown) formed on the back plate 31 from electromagnetic interference.

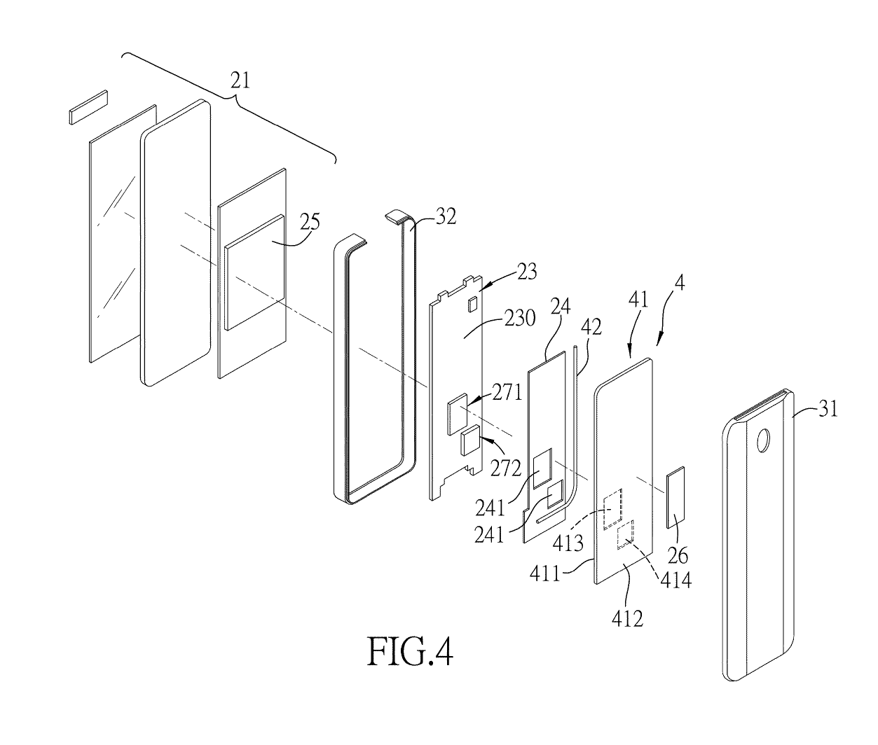

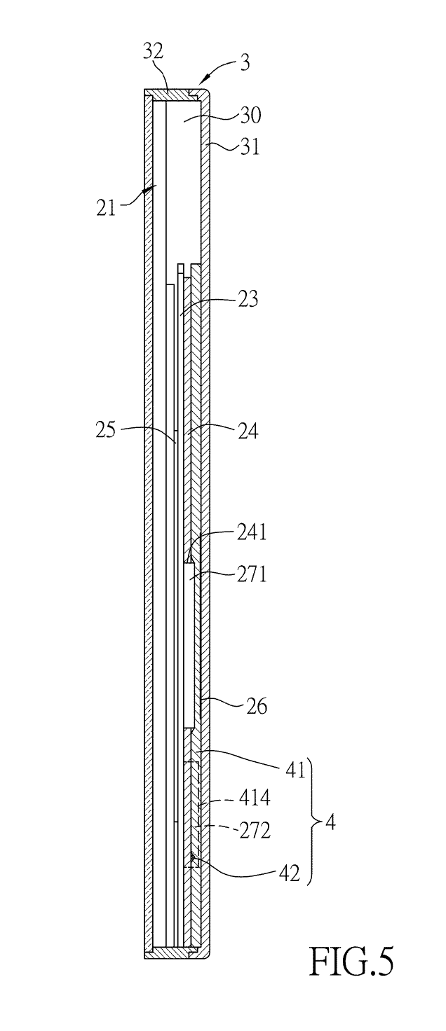

Referring to FIGS. 4 and 5, in certain embodiments, the heat dissipating unit 4 further includes a heat pipe 42 that is disposed between the EMI-shielding metal sheet 24 and the heat dissipating panel 41 and that is connected to the heat dissipating panel 41 for enhancing dissipation of the heat generated from the first and second electronic components 271, 272.

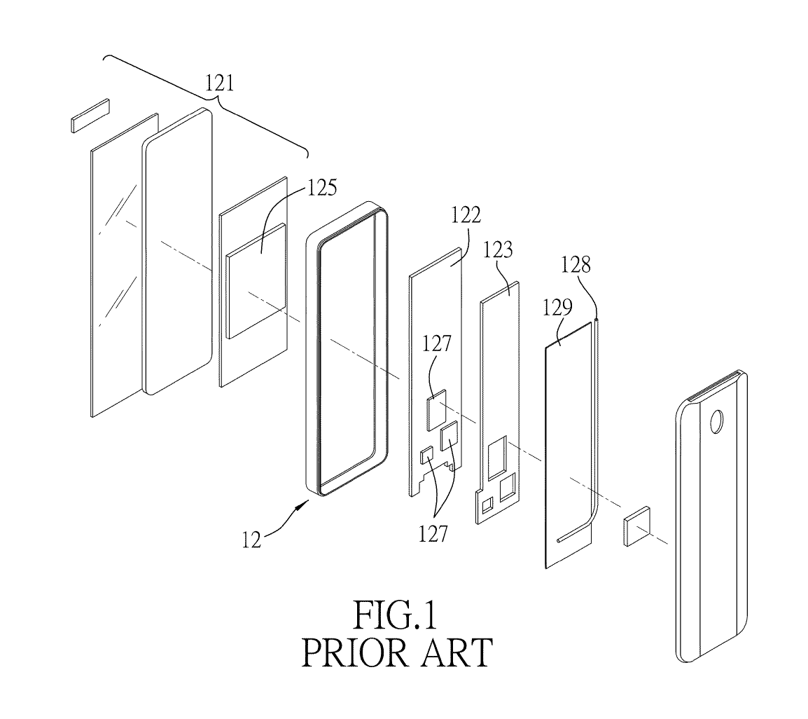

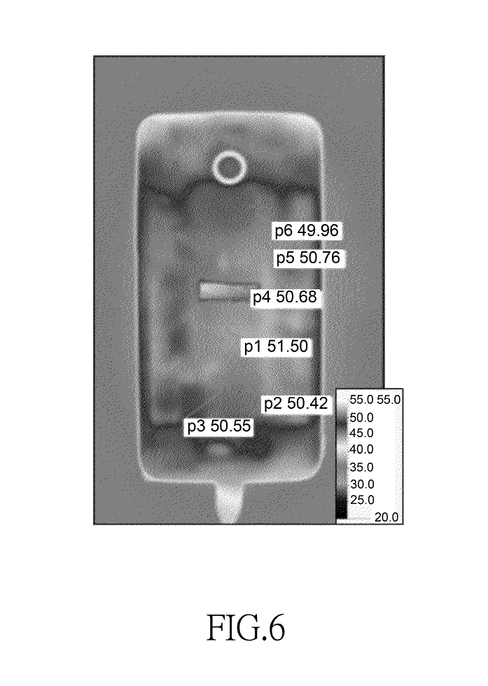

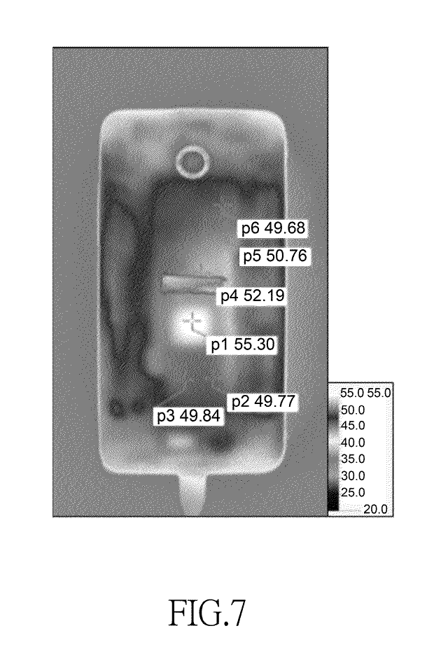

FIGS. 6 and 7 are thermal images showing thermal test results (thermal imaging data) for the electronic device of FIG. 2 (referred to as Example) and the electronic device of FIG. 1 (referred to as Comparative Example), respectively. The heat dissipating panel 41 of the Example is made from an alloy with a composition comprising 10 wt % indium, 20 wt % gallium, 5 wt % zinc, 60 wt % tin, and 5 wt % copper. The heat dissipating panel of the Comparative Example is made from a graphite plate. As shown in FIG. 7, the electronic device of the Comparative Example exhibits a hot spot (p1) with a temperature much higher than surrounding regions (p2 to p4). However, as shown in FIG. 6, the electronic device of the Example exhibits a uniform temperature at the spot (p1) and its surrounding regions (p2 to p4), which is an indication of having an excellent heat dissipating efficiency as compared to that of the Comparative Example.

In certain embodiments, with the inclusion of at least one recess 413 in the heat dissipating panel of the electronic device of the disclosure, the aforesaid drawback associated with the prior art may be alleviated.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An electronic device comprising:
a circuit board having a board surface;
a heat-generating source including a first electronic component mounted on said board surface of said circuit board; and
a heat dissipating panel stacked over said circuit board, having a panel surface, and formed with a first recess that is indented inwardly from said panel surface and that is defined by a first recess-defining wall;
wherein said first electronic component protrudes from said board surface into said first recess to contact said first recess-defining wall.

2. The electronic device as claimed in claim 1, wherein said first electronic component has a free end that is distal from said board surface, said first recess-defining wall having an open end and a blind end that is opposite to said open end and that is distal from said panel surface, said free end of said first electronic component contacting said blind end of said first recess-defining wall.

3. The electronic device as claimed in claim 2, wherein said panel surface is planar, said heat-generating source further including a second electronic component that protrudes from said board surface and that has a free end that is distal from said board surface, said free ends of said first and second electronic components having different heights relative to said board surface, said heat dissipating panel being further formed with a second recess that is indented inwardly from said panel surface and that is defined by a second recess-defining wall, said second recess-defining wall having an open end and a blind end that is distal from said panel surface, said free end of said second electronic component contacting said blind end of said second recess-defining wall.

4. The electronic device as claimed in claim 2, wherein said first electronic component extends fittingly into said first recess.

5. The electronic device as claimed in claim 1, further comprising a EMI-shielding metal sheet that is sandwiched between said circuit board and said heat dissipating panel, said first electronic component extending through said EMI-shielding metal sheet.

6. The electronic device as claimed in claim 5, wherein said EMI-shielding metal sheet contacts said board surface of said circuit board and said panel surface of said heat dissipating panel.

7. The electronic device as claimed in claim 1, further comprising a housing, said circuit board and said heat dissipating panel being mounted in said housing, said heat dissipating panel contacting said housing.

8. The electronic device as claimed in claim 7, wherein said housing includes a back plate and a frame part, said back plate having a peripheral end, said frame part being connected to said peripheral end of said back plate and surrounding said circuit board and said heat dissipating panel.

9. The electronic device as claimed in claim 8, further comprising a display panel that is surrounded by said frame part.

10. The electronic device as claimed in claim 1, further comprising a heat pipe connected to said heat dissipating panel.

11. The electronic device as claimed in claim 1, wherein said heat dissipating panel is made from an alloy that comprises a primary alloy portion and a secondary alloy portion, said secondary alloy portion containing metal selected from the group consisting of copper, cobalt, nickel, and chrome.

12. The electronic device as claimed in claim 11, wherein said primary alloy portion comprises indium, gallium and zinc.

13. The electronic device as claimed in claim 12, wherein said primary alloy portion further comprises a metal that is selected from the group consisting of silver, tin, and magnesium.

14. The electronic device as claimed in claim 13, wherein said metal that is selected from the group consisting of silver, tin, and magnesium is in an amount less than 65 parts by weight based on 100 parts by weight of said primary alloy portion.

15. An electronic device comprising:
a housing;
a circuit board having a board surface;
a heat-generating source comprising a first electronic component mounted on said board surface of said circuit board, wherein said first electronic component has a free end that is distal from said board surface; and
a heat dissipating panel stacked over said circuit board, having a panel surface, and formed with a first recess that is indented inwardly from said panel surface and defined by a first recess-defining wall, said first recess-defining wall having an open end and a blind end that is opposite to said open end and that is distal from said panel surface;
wherein said free end of said first electronic component contacts said blind end of said first recess-defining wall; and
wherein said heat dissipating panel contacts said housing.

16. The electronic device as claimed in claim 15, wherein said panel surface is planar, said heat-generating source further comprising a second electronic component that protrudes from said board surface and that has a free end that is distal from said board surface, said free ends of said first and second electronic components having different heights relative to said board surface, said heat dissipating panel being further formed with a second recess that is indented inwardly from said panel surface and that is defined by a second recess-defining wall, said second recess-defining wall having an open end and a blind end that is distal from said panel surface, said free end of said second electronic component contacting said blind end of said second recess-defining wall.

17. The electronic device as claimed in claim 15, wherein said heat dissipating panel is made from an alloy that comprises a primary alloy portion and a secondary alloy portion, said secondary alloy portion containing metal selected from the group consisting of copper, cobalt, nickel, and chrome.

18. The electronic device as claimed in claim 17, wherein said primary alloy portion comprises indium, gallium and zinc.

19. An electronic device comprising:
a circuit board having a board surface;
a heat-generating source including at least one electronic component mounted on the board surface of the circuit board; and
a heat dissipating panel aligned with the circuit board, having a panel surface, and formed with a recess corresponding to the at least one electronic component, the recess being indented inwardly from the panel surface and that is defined by a recess-defining wall,
wherein the at least one electronic component protrudes from the board surface into the recess to contact the recess-defining wall.

20. The electronic device as claimed in claim 19, further comprising:
at least another electronic component that protrudes from the board surface and the heat dissipating panel including a recess corresponding to the at least another electronic component, wherein each recess and each electronic component has a different height relative to the board surface.
